(19) United States
(12) Patent Application Publication
(10) Pub. No.: US 2015/0180081 A1
(43) Pub. Date: Jun. 25, 2015

(54) Traction Battery

(71) Applicant: Hoppecke Batterien GmbH & Co. KG, Brilon (DE)

(72) Inventor: Heinrich Kesper, Willingen (DE)

(21) Appl. No.: 14/571,388

(22) Filed: Dec. 16, 2014

(30) Foreign Application Priority Data
Dec. 20, 2013 (EP) 13199013.7

(51) Int. Cl. H01M 10/04; H01M 4/14; H01M 4/75

(52) U.S. Cl. CPC H01M 10/0413; H01M 4/75; H01M 4/14; H01M 2220/20

(57) ABSTRACT

The disclosure relates to a battery, in particular a traction battery, comprising a battery casing providing connecting poles on the upper side thereof and having arranged therein alternating negative and positive electrodes connected to the connecting poles, the positive electrodes being configured as tubular plates and each including a current-collecting strip and a plurality of cores extending parallel to each other from the current-collecting strip, the cores being oriented in such a manner as to run transversely and preferably orthogonally to the height direction of the battery casing.

### CROSS-REFERENCE TO RELATED APPLICATIONS

This application claims priority to European Application No. 13199013.7, filed on Dec. 20, 2013. The entire disclosure of the above application is incorporated herein by reference.

### FIELD

The invention relates to a battery, in particular a traction battery preferably configured as a lead-acid battery, comprising a battery casing providing connecting poles on the upper side thereof and having arranged therein alternating negative and positive electrodes connected to said connecting poles, the positive electrodes being formed as tubular plates and each having a current-collecting strip and a plurality of cores extending parallel to each other from the current-collecting strip, and said negative electrodes being formed as grid plates and each comprise a current-collecting strip passing into a current-collecting lug, and a bar grate arranged thereon, which provides grid arrays filled with active material.

### BACKGROUND

This section provides background information related to the present disclosure which is not necessarily prior art.

A battery of the generic kind is known from U.S. Pat. No. 4,508,801 A. For additional prior art, it may be referred for example to DE 10 2008 034 587 A1, GB 387,906, U.S. Pat. No. 4,680,242, and U.S. Pat. No. 2,570,677.

A traction battery typically comprises a battery casing. The latter has a container open at the top and a cover closing said container when the battery is used as intended. On upper side of the battery casing, mostly on the cover, connecting poles for an electrical contact are provided.

The battery casing serves to receive positive and negative electrodes on the one hand and sulfuric acid as an electrolyte on the other hand. The negative and the positive electrodes are electrically contacted with the connecting poles and are arranged in alternating manner.

In a preferred configuration, the negative electrodes are formed as so-called grid plates. The grid plates have a current-collecting strip and a bar grate arranged thereon, which provides grid arrays filled with active material.

The positive electrodes are preferably configured as tubular plates. The tubular plates each have a current-collecting strip and a plurality of cores extending in the height direction of the battery casing. Further provided is a tube pocket, which comprises a number of tubes corresponding to the number of cores. In the condition ready for use, a core is arranged inside each tube and the hollow space between the core and the tube is filled with active material, usually a paste of lead oxide, sulfuric acid and water. To prevent the active material leaking from the tube pocket, the tube openings opposite the current-collecting strip are closed with a closing strip. As a tube pocket material there may be particularly considered a woven or nonwoven fabric.

Specially constructed positive electrodes are known from GB 2,069,225 A and JP 61220276A. The positive electrode as disclosed in JP 61220276 A has a design in which the cores are oriented orthogonally to the height direction of the battery casing. The cores are each received by a tube pocket tube filled with active material.

Separators are used for electrically decoupling the negative electrodes and the positive electrodes disposed in the battery casing, and a separator is arranged between a negative and a positive electrode respectively. According to a possible configuration, so-called separator pockets or separator sleeves are used which serve to receive a respective negative electrode.

Though batteries of the above-described kind have proven themselves in practical use for many decades, there is nevertheless a need for improvement.

Various construction sizes of batteries are known in prior art. The capacity of a battery increases with its construction size. The external dimensions and particularly those in the width direction of traction batteries are fixed by relevant specifications and standards. Therefore, only the height direction and the depth direction, but not the width direction of a battery are available as the degrees of freedom for different construction sizes. Accordingly, batteries having a high capacity have a comparatively large height. The buildup of the battery in the height direction is necessitated by a desired capacity.

A structure that grows in the height direction also increases the length of the cores of the positive electrodes that are constructed as tubular plates. This in turn leads to an increasing length of the current path when the battery is used as intended, and unavoidably to a higher electrical resistance which causes voltage drops during operation. An additional aspect is that batteries of this kind are increasingly used in high-current applications in the corresponding domains such as discharging by the operation of rotary current motors for example or charging by means of modern charging magnet systems and/or energy recovery systems (recuperation) for example. The input and/or output of high currents leads to negative side effects which become increasingly grave as the length of the current path increases, one such side effect being the development of heat due to an increasing internal resistance as a consequence of an increasing length of the current path. This causes the disadvantage of a shorter service life and shorter discharging cycles at the use of the battery. For this reason, prior art batteries reaching a certain size are not suitable or suitable only to a limited extent for high-current applications. This particularly applies to batteries having a construction size that is desired by the market because of the high capacity. Accordingly, there are two conflicting demands: on the one hand a battery having a high capacity and yet a long service life and on the other hand a battery suitable for high-current applications. Batteries of the above-described generic kind do not meet these demands.

### SUMMARY

In view of the above, it is an object of the present invention to improve a battery and particularly a traction battery of the above-mentioned kind to that effect that the battery has a high capacity while being suitable for high-current applications.

To achieve this object, the invention proposes a battery of this generic kind characterized in that the cores of the positive electrodes are oriented in such a manner as to run transversely and preferably orthogonally to the height direction of the battery casing and that the current-collecting strip of the negative electrodes is oriented in such a manner as to run in the height direction of the battery casing.

Turning away from the previous structure, the cores of the battery of the invention are not oriented in a manner such as to run in the height direction of the battery casing, but instead transversely and preferably orthogonally to the battery casing. The configuration that has been used in prior art since decades is thus replaced. The arrangement of the cores which are twisted by preferably 90° compared to prior art advantageously allows obtaining the desired service life while making the battery suitable for high-current applications. Therefore, the configuration according to the invention is not subject to a limitation of size in order to provide corresponding capacities.

As a result of the orientation of the cores transversely to the height direction of the battery casing, there is obtained a construction size of the battery in the height direction thereof which does not depend on the core length. The cores of the inventive battery are equally long throughout the construction sizes of the battery. Accordingly, the current path provided by each core and along with it the internal resistance are always equally large, independently from the construction height of the battery. Differently from prior art, the capacity is increased not by increasing the length of the cores, but by increasing the number of the cores. The length of the cores remains unchanged so that the internal resistance of a core is independent from the construction size despite an increased capacity. Batteries having a comparatively large construction size are thus enabled to receive or output high amperages equally well. Therefore, the battery according to the invention is suitable for high-current applications even if configured with a large size for high capacities.

The construction known in prior art uses an upper frame extending transversely to the height extension of the battery, which carries a current-collecting lug on the side of the connecting poles and carries the cores connected thereto on the side opposite said current-collecting lug. Here the core length increases with an increasing battery size. The inventive configuration does not such an upper frame. It uses a current-collecting strip, which is oriented in the height direction of the battery casing, and the individual cores branch off said current-collecting strip. The cores do not run in the height direction of the battery casing, but instead transversely to the battery casing, i.e. in the width direction of the battery casing. To be able to receive more active material in order to increase the capacity, the construction size of the battery in the height direction must be appropriately designed. In the configuration according to the invention, this leads to an extended current-collecting strip on the one hand and to a larger number of cores arranged thereon on the other hand.

For minimizing the internal resistance provided by each current-collecting strip, the invention proposes that the current-collecting strip is formed in a manner tapering towards its end opposite the connecting poles. The cross sectional area of the current-collecting strip thus increases with the number of cores arranged thereon in the height direction of the battery, i.e. from the end remote from the connecting pole.

The end section of the current-collecting strip on the connecting pole side serves as a current-collecting lug. This is advantageous particularly from the production-related viewpoint, because there is no more need for forming an additional current-collecting lug.

The cores preferably have a star-shaped cross section, at least in sections, in order to guarantee an optimal relationship between the contact area between the active material and the core surface on the one hand and the volume space provided by a tube of a tube pocket for receiving said active material on the other hand.

The transverse orientation of the cores with respect to the battery casing is advantageous in many aspects, and additionally also synergetic effects are obtained as follows. The internal resistance determined by the longitudinal extent of a core is independent from the construction height of the battery. This leads to less undesired negative side effects such as a heat development for example occurring during charging and discharging even in high-current applications. Therefore, differently from prior art, the construction size has no negative influence on the high-current capability so that even batteries having a comparatively high capacity are equally suited for high-current applications.

The active material is utilized in a more uniform manner both during charging and discharging of the battery. With the construction according to the invention, the utilization of the active material which is differs as a function of the distance from the current collector does not deteriorate in larger construction sizes because the longitudinal extent of the cores is always equal, independently from the construction size of the battery.

Additionally, the construction according to the invention affords a more uniform distribution of the acid in the electrolyte. Due to the changing acid concentration during a charging and/or discharging process, a gradient is produced in the acid density distribution. The result inevitably is an acid density stratification, wherein the acid having the strongest concentration, i.e. the acid having the highest density, accumulates in the bottom part of the accumulator casing. To obtain a homogenization, it is known in prior art to provide for thorough mixing of the acid, which can take place for example by means of rising gas bubbles as a consequence of a battery overcharge.

The problem of said acid density stratification is minimized in the configuration according to the invention, i.e. the gradient of the acid density distribution is smaller than in prior art. This is achieved as a result of the uniform current flow due to the cores, which are always equally long, regardless of the construction size.

Concerning the production-related aspect, it is an advantage that the plate configured in accordance with the invention can be manufactured in the same way using prior art production machinery that is practically unmodified. It is thus possible in the production or manufacture to resort to proven materials and techniques. Therefore, the advantages of the novel battery construction are not achieved at the expense of the manufacture.

Concerning its geometrical structure, the configuration of the invention is less complicated than in prior art, which is due to the lateral arrangement of the current-collecting strip oriented in the height direction. Moreover, differently from prior art, the cores are comparatively short in the direction of their longitudinal extent, especially in larger construction sizes of batteries. This allows a manufacture as a drop cast or gravity die-cast part, because the fluid lines for the casting material are correspondingly short. As this drop casting or gravity die casting technique cannot be applied to the known positive electrodes on account of the core lengths, this technique simplifies the manufacture compared to the conventional cast parts known in prior art.

With the configuration according to the invention, an improvement is also achieved concerning the filling of the tube pockets with active material. It is possible during the injection of active material to achieve a more uniform density distribution of the active material inside the tube pocket, because even in designs having a larger size, the tube pockets are designed with a shorter length corresponding to the configuration of the cores. Provided that the active material is injected using movable pusher rods, the invention achieves an improvement in so far as the move-in or move-out times are reduced compared to prior art, which is due to the shortened tube pockets. Independently of the method for introducing the active material into tube pocket, there is obtained the advantage of a lower tendency of the cores to deform during the introduction of the active material. The tendency to deform increases with an increasing core length. Accordingly, the core configuration of the invention is advantageous also in that respect, because the configuration is independent from the construction size of the cores.

Additionally, in combination with the negative plate, there is obtained a current flow length that is always equal due to the lateral current collection as provided according to the invention. While it makes a difference in the known plates whether an electron from an upper portion of the positive plate migrates to an upper portion of the negative plate or an electron that comes from a lower portion of the positive plate and must be transferred to a lower portion of the negative plate, these differences in the current flow length do not exist in a lateral current collection as provided by the inventive configuration. Here the current flow lengths are always equal, which allows a more effective and uniform utilization.

Accordingly, the configuration of the invention affords a more uniform discharge of current and charging with current, a more homogeneous filling with active material, the possibility of employing a gravity die casting process, the formation of current flow lengths which are always equal, and independence from the capacity size, i.e. the size of the battery in the direction of its height. Additionally, known manufacturing techniques, know materials and known charging magnet systems can be used, which affords operational safety together with a significant improvement concerning high-current applications.

In combination with a positive electrode, the invention also proposes that the negative electrodes be configured as grid plates and each include a current-collecting strip passing into a current-collecting lug, and a bar grate that provides grid arrays filled with active material, said current-collecting strip being oriented in the height direction of the battery casing.

The negative electrode is configured as a grid plate in a manner known per se. This grid plate provides a plurality of grid arrays, which are filled with active material in the finally mounted state. Differently from prior art, the current-collecting strip to which the bar grate of the grid plate is connected is not formed as an upper frame running transversely to the vertical extent of the battery, but runs in the direction of the height of the battery casing and is thus oriented in a manner offset by preferably 90° compared to prior art. In this way, a lateral arrangement of the current-collecting strip with respect to the bar grate is achieved which in combination with the positive electrode results in the above-mentioned advantage of the current flow paths always being equally long. Concerning the production-related aspect, a simplification is obtained as a result of the current-collecting strip directly passing into the current-collecting lug. Accordingly, differently from prior art, any special design of the current-collecting lug is not required.

According to a further feature of the invention, the bar grate has cross bars and main bars, said cross bars running transversely to the height direction of the current-collecting bar and having a diameter larger than that of the main bars.

The diameter of the cross bars is determined by production-related aspects. Accordingly, a diameter must be chosen for the cross bars, which allows a manufacture of a bar grate in the desired quality and configuration using a drop cast technique. This requires corresponding diameters of the cross bars in order to afford a corresponding distribution of the casting material during the casting process. The diameter of the main bars is determined by the production conditions and can be smaller than that of the cross bars. Production-related, the channels of the die casting mold forming the later cross bars accordingly serve as the main casting direction so that the production direction is in the direction of the orientation of the cross bars.

The configuration according to the invention provides for a lateral current collection, namely towards the current-collecting strip formed laterally of the bar grate. The main current collection direction accordingly extends in the direction of the cross bars. The diameter of the cross bars is determined by production conditions and is larger than that of the main bars, which fact promotes the current output toward the current-collecting strip. For this reason, in the embodiment according to the invention, the production direction for the bar grate coincides with the current-collecting device, with the result that the current flow is made more uniform throughout the negative electrode. This is not permitted by the known configuration because here the production direction of the bar grate and the main current-collecting direction are oriented in such a manner as to be relatively rotated by 90°.

The orientation of the negative plate in accordance with the invention also allows a manufacture of the plate in a continuous process, which is not possible with the pre-known plates because of the design and orientation of the current-collecting strip with the current-collecting lug arranged thereon. In this case, a corresponding grid dimension is established for each battery size, and the plates must be manufactured corresponding to this grid dimension in a discontinuous process. The configuration according to the invention enables a continuous endless production. Accordingly, there is produced an endless bar grate strip that must be cut to length corresponding to the later battery size for forming individual bar grates. On the side of the connecting pole one or two grid intersections of the bar grate must be removed for instance by punching in order to expose the end part of the current-collecting strip serving as a current-collecting lug. Here, the cutting process and the removal of said grid intersections can be carried out in one working step. The construction according to the invention thus affords a considerably higher productivity of the overall production process.

According to a further feature of the invention it is provided that the cross bars of the negative electrode and the cores of the positive electrode are equally long in their respective longitudinal extent, which additionally promotes the above-described advantage of the current flow length always being equal.

### DRAWINGS

The drawings described herein are for illustrative purposes only of selected embodiments and not all possible implementations, and are not intended to limit the scope of the present disclosure.

Further features and advantages of the invention will become apparent from the following description by way of the drawing figures wherein it is shown by:

FIG. 1 is an exploded schematic view of a battery according to prior art;

FIG. 2 is a schematic perspective view of the core arrangement of a positive electrode of a battery according to the invention;

FIG. 3 is a schematic perspective view of a positive electrode of a battery according to the invention;

FIG. 4 is a schematic lateral view of a positive electrode of a battery according to the invention;

FIG. 5 is a schematic lateral view of a negative electrode of a battery according to the invention; and

FIG. 6 is a schematic lateral view of a positive and a negative electrode of a battery according to the invention.

Corresponding reference numerals indicate corresponding parts throughout the several views of the drawings.

### DETAILED DESCRIPTION

Example embodiments will now be described more fully with reference to the accompanying drawings.

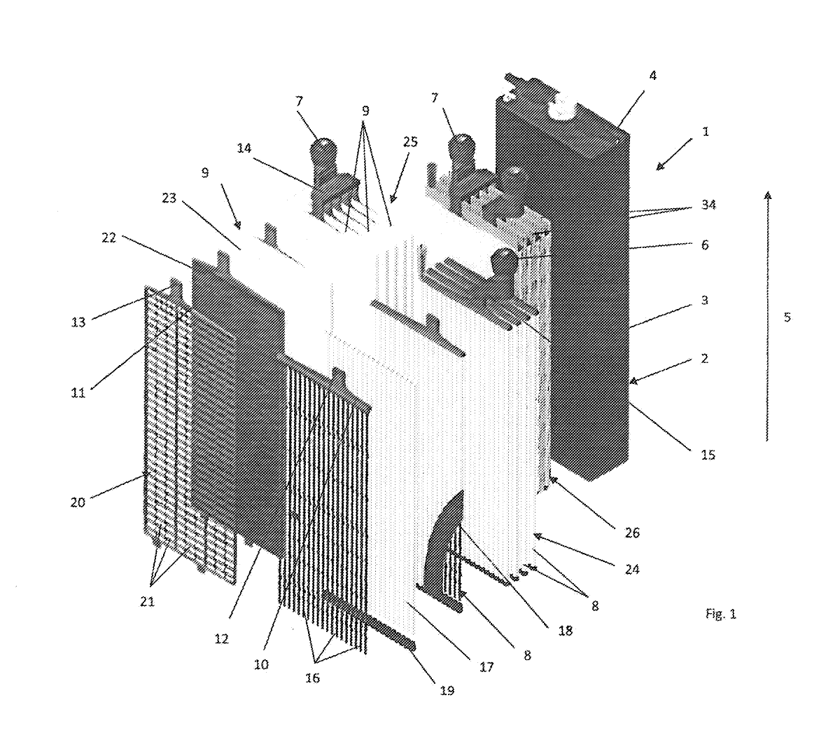

FIG. 1 shows in an exploded perspective view a traction battery 1 according to prior art. This battery has a casing 2 including a container 3 that is open on the upper side thereof and is closed by a cover 4 in its finally mounted state.

Depending on the battery voltage that is desired for the respective application, it is also possible to combine several batteries 1 into a common battery unit. The battery 1 which is shown in an exemplary manner in FIG. 1 and which can also be referred to as a cell, relates to a 2V configuration. For a 12V or 24V configuration, a corresponding number of such cells must be connected to each other.

In the finally mounted state, an overall plate pack 26 is inserted in said container 3, said pack having connecting poles on the upper side thereof, namely a positive pole 6 and a negative pole 7. In the finally mounted state, said connecting poles penetrate through openings formed in the cover 4 in order to be accessible for a user from outside.

The overall pack 26 is composed of a positive plate pack 24 and a negative plate pack 25, the positive electrodes 8 and the negative electrodes 9 alternating in the finally mounted state.

A positive electrode 8 has a current-collecting strip 10 in the form of an upper frame extending transversely to the height direction of the casing 2. On the upper side of the current-collecting strip 10 a current-collecting lug 12 is provided. In the finally mounted state, the current-collecting lugs 12 of several positive electrodes 10 are electrically coupled to each other via a common bridge 15 and are connected to the positive pole 6 of the battery 1.

On the side of the current-collecting strip 10 remote from the connecting pole, cores 16 are branched off, which in their longitudinal orientation extend in the height direction 5 of the casing 2. In the finally mounted state, said cores 16 are received in a tube pocket 17 that provides one tube for each core 16. In the finally mounted state, the free volume space within each tube is filled with active material 18. Thus an arrangement is obtained for each tube of the tube pocket 17 in which the core 16 penetrates the associated tube in the longitudinal direction, and the annular space between each core 16 and the inner wall of the tube is filled with active material.

To prevent active material 18 from leaking from the tube pocket 17 at the lower side thereof, said tube pocket 17 is closed on the bottom side by means of a closing strip 19 that is provided for this purpose.

The negative electrode 9 also has a current-collecting strip 11 that is designed as an upper part of a frame and extends transversely to the height direction 5 of the casing 2. For the connection to the negative pole 7 of the battery, one current-collecting lug 13 for each negative electrode 9 is used which is disposed on the upper side of the respective current-collecting strip 11, and the current-collecting lugs 13 of several negative electrodes 9 are electrically contacted by means of a common bridge 14.

To the current-collecting strip 11a bar grate 20 is joined which provides several grid arrays 21 filled with active material 22. The bar grate 20 comprises main bars extending in the height direction 5 and cross bars extending transversely to said main bars, the diameter of the main bar exceeding the diameter of the cross bars.

To avoid shorting, the positive electrodes 8 and the negative electrodes 9 are electrically decoupled from each other by means of a separator that is disposed for this purpose. In the illustrated embodiment, a corrugated separator sheet 34 is used as a separator. Further, a nonwoven pocket 23 is provided for each negative electrode 9, and a respective negative electrode 9 is inserted in the respective pocket.

The above-described traction battery 1 is available in configurations of different size, and the capacity of the transaction battery 1 increases with an increasing size. As parameters for dimensioning traction batteries 1 that are in line with the market, the height direction 5 or the depth direction can be used, but not the width direction, which is due to relevant standards and specifications. Traction batteries 1 having a different capacity thus mainly differ in their reach in the height direction. For this reason, traction batteries 1 of a different construction size are basically similar in structure and design. Only the positive electrodes 8 or the negative electrodes 9 are configured with a larger length, i.e. have a larger reach in the height direction 5, in order to receive more active material 18 for increasing the capacity as a consequence of a larger construction height.

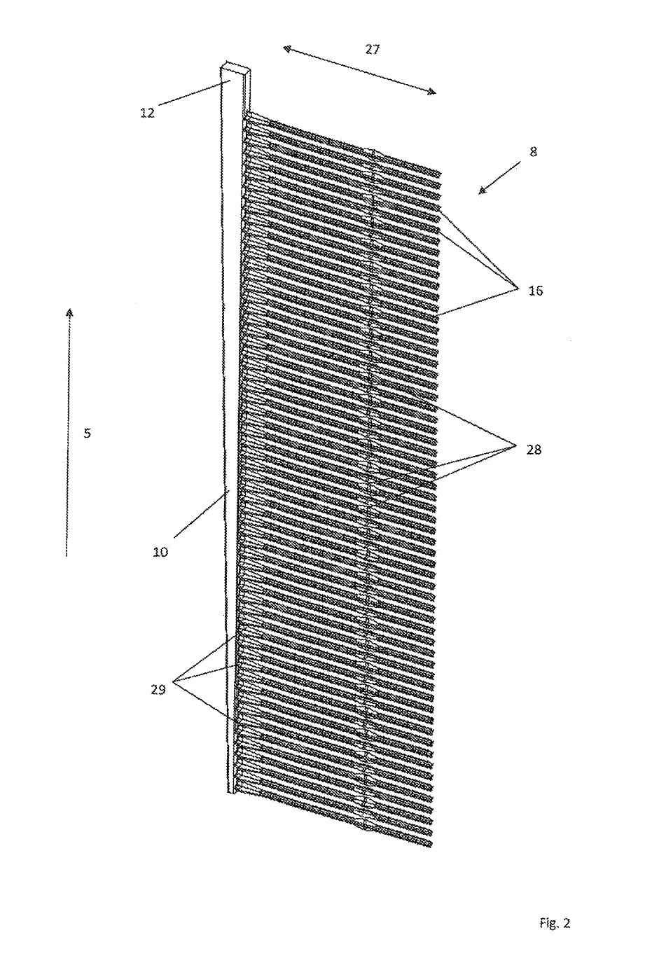

The configuration according to the invention is apparent from the further FIGS. 2 to 6, which for reasons of simplicity only illustrate the positive electrodes 8 and the negative electrodes 9 in different views, while the remaining usual components of the battery 1 are not shown for the sake of clarity.

FIG. 2 shows in a perspective schematic view the core arrangement of a positive electrode 8 according to the invention. As shown in this Figure, the positive electrode 8 has a current-collecting strip 10. Differently from prior art, said strip extends in the height direction 5 of the battery casing 2, and the end section of the current-collecting strip 10 on the side of the connecting pole serves as a current-collecting lug 12. In the illustrated embodiment, said current-collecting strip 10 is configured in a manner so as to taper toward its end opposite the connecting poles.

The positive electrode 8 further comprises a plurality of cores 16 branching off the current-collecting strip 10 while extending parallel to each other. Differently from prior art, said cores are oriented transversely to the height direction 5, i.e. the longitudinal extent thereof is transversely to the height direction 5 of the casing 2. In the illustrated embodiment, the cores 16 are orthogonal, i.e. the respective longitudinal direction is arranged at an angle of 90° to the height direction 5 of the casing 2.

The transverse orientation of the cores 16 has the advantage that the length of the cores 2, i.e. their respective extent in the longitudinal direction 27, is always equal, regardless of the construction size of the battery. Accordingly, in the case of a larger battery, for increasing the capacity, said current-collecting strip extending in the height direction 5 must be made longer and the number of the cores 16 to be provided in total must be increased corresponding to that larger length. But the respective length of the cores always remains equal and does not increase with a larger construction size of the battery 1 as with prior art.

The configuration according to the invention has a number of advantages. One particular advantage is that the internal resistance of a core 16, which is determined by the length of a core 16, remains equal, independently of the construction size. For this reason, the traction battery according to the invention is also suited for high-current applications, even with a large construction size.

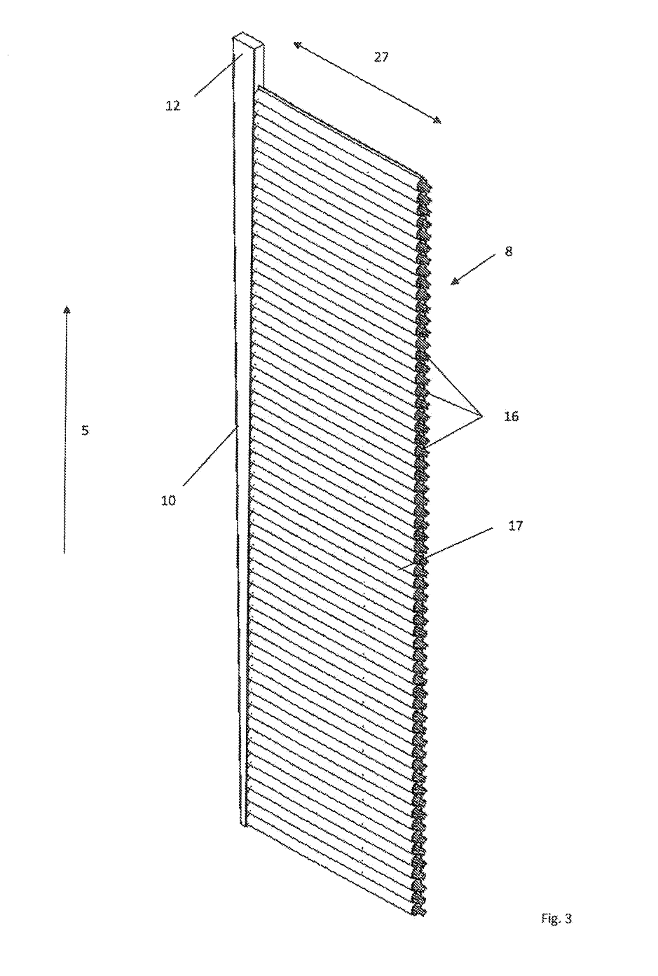

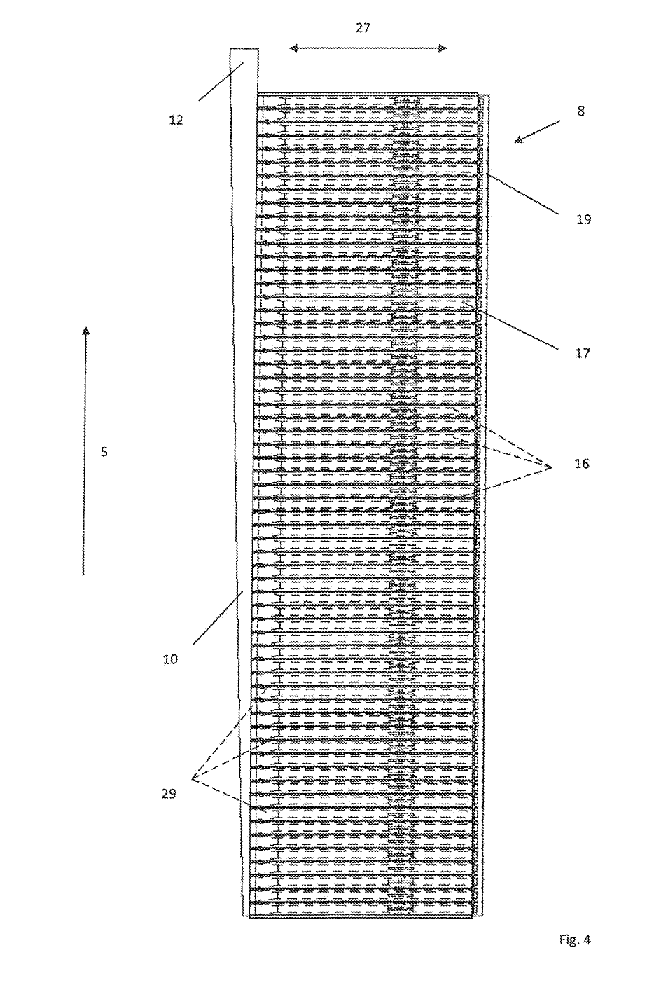

FIG. 3 shows the positive electrode 8 with a tube pocket 17 attached to the cores 16. In a manner known per se, the annular space of the tube pocket 17 respectively surrounding a core 16 is filled with active material. This can be seen especially in FIG. 4 showing a closing strip 19 for closing the tube pocket 17 on its end opposite the current-collecting strip.

To dispose the tube pocket 17 in a stable position, spacers 28 provided on the cores 16 and connecting sections 29 are used, which are preferably tapered toward the current-collecting strip 10.

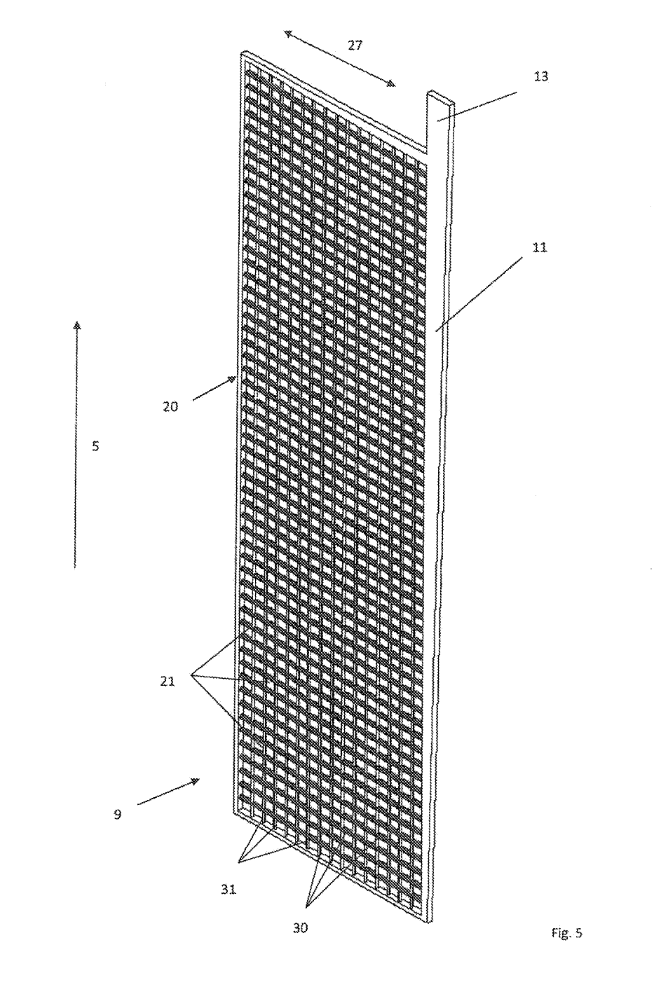

The configuration of a negative electrode 9 is shown in the schematic lateral view of FIG. 5. It can be seen that the negative electrode 9 includes a current-collecting strip 11 in a manner known per se. Differently from prior art, this current-collecting strip is not arranged transversely, but instead longitudinally to the height direction 5 and thus extends in the height direction 5. The current-collecting strip 11 passes directly into a current-collecting lug 13 provided on the side of the connecting pole.

The negative electrode 9 further includes a bar grate 21. The bar grate is disposed on the current-collecting strip 11, and differently from prior art, there is not obtained a stacked arrangement with respect to the height direction 5, but a sidewise arrangement. In the illustrated embodiment, said bar grate 20 extends to the left from the current-collecting strip 11.

The bar grate 20 includes grid arrays 21 filled with active material 22 in the finally mounted state. Each grid array 21 is delimited by cross bars 30 on the one hand and main bars 31 on the other hand. The cross bars 30 have a diameter larger than that of the main bars 31. This structure is inversed compared to prior art, because differently from prior art, the cross bars 30 and not the main bars 31 are larger in diameter. This has the advantage that the production direction of the negative electrodes 9 produced by a drop casting process for example coincides with the later sideward direction of current drain, namely to the right and toward the current-collecting strip 11 formed laterally. The cross bars 30, whose material is stronger for reasons of manufacture, hence lie in the current flow direction, which permits a more uniform operation of the negative electrode 9.

Concerning production-related aspects, the configuration according to the invention is also advantageous in so far as it permits a continuous endless production of the negative electrode 9. It is possible to produce a grid strip that is endless in the height direction 5 and merely needs to be cut to length and requires removal of two intersections of the bar grate 29 adjacent the current-collecting lug 13 to spare said current-collecting lug 13. This can be carried out in a punching operation.

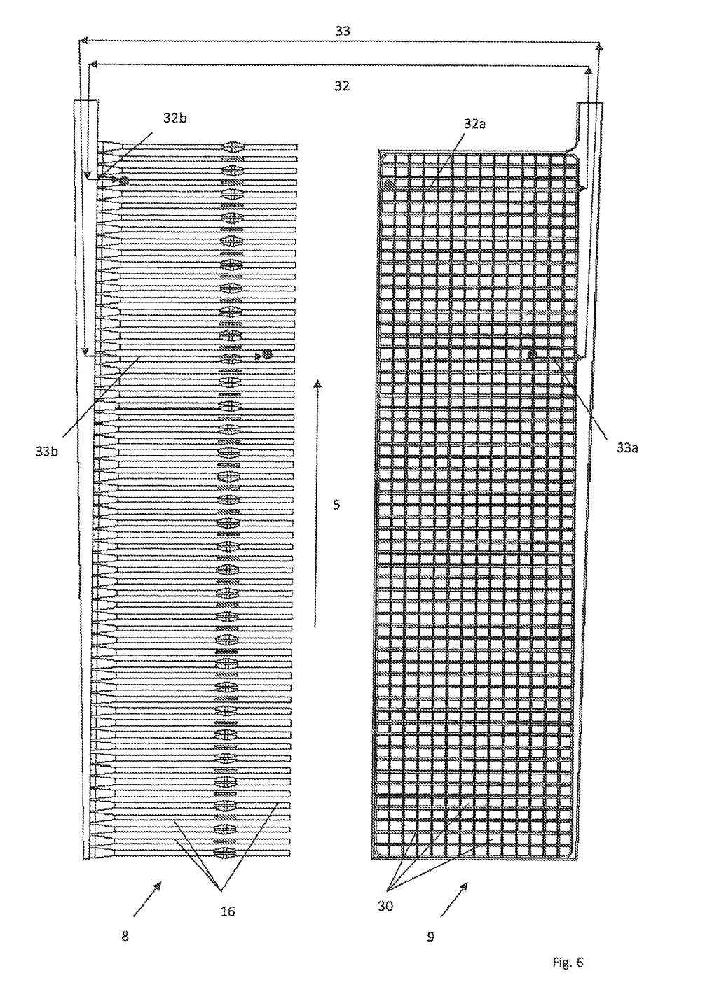

The positive electrode 8 combined with the negative electrode 9 provides the additional advantage that the current paths 32 and 33 are always equal regarding the cores 16 and the bar grate 20, as shown in an exemplary manner in FIG. 6.

FIG. 6 shows a positive electrode 8 and a negative electrode 9, which are illustrated in juxtaposition for graphical reasons. In the finally mounted state, said electrodes 8 and 9 are arranged one behind the other. When a consumer is connected between the connecting poles, current flows from the negative electrode 9 to the associated positive electrode 8, as schematically shown by the plotted current paths 32 and 33. As apparent from these two current paths 32 and 33, which are plotted in an exemplary manner, the current path with regard to the cores 16 on the one hand and with regard to the bar grate 20 on the other hand always has an equal length, which is due to the configuration of the electrodes 8 and 9 in accordance with the invention. When the distance to be travelled by the current with regard to the bar grate 20 of the negative electrode 9 is comparatively long, the distance with regard to the cores 16 of the associated positive electrode 8 is comparatively short, as shown by the sections 32a and 32b of the current path 32. Decisive is that the respective sections of both current paths 32 and 33 are substantially equally long so that current is fed to and drained from the battery 1 in a uniform manner during charging and discharging. In a battery according to prior art, current paths are obtained which are differently long, because a comparatively short current path at the negative electrode 9 causes current path at the positive electrode 8 that is also comparatively short. On the other hand, a comparatively long current path at the negative electrode 9 causes a comparatively long current path at the positive electrode 8. The transverse orientation according to invention produces relief in the way already described earlier. The above-described transverse orientation leads to a further advantage, particularly regarding the positive electrode 8. During the operation in the intended manner, the current path respectively leads via the cores 16 and into the current-collecting strip 10 connected to the cores. In the transition zone of each core 16 to the current-collecting strip 10 the current density increases as a function of the core length. The current density in the transition zone between the respective core 16 and the current-collecting strip 10 is the higher the longer the respective cores 16 are. On the other hand, it is essential to avoid high current densities, which lead to an increased heat development and to corrodibility. If high current densities are applied, the service life will be reduced. As the cores 16 of the battery 1 of the invention are smaller in their longitudinal extent than the cores 16 according to prior art, even in larger battery configurations, the service life to be expected at the same capacity of a battery according to the invention increases compared to that of a battery configuration according to prior art.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery, in particular a traction battery, comprising:
a battery casing providing connecting poles on the upper side thereof and having arranged therein alternating negative and positive electrodes connected to the connecting poles, the positive electrodes being configured as tubular plates and each including a current-collecting strip and a plurality of cores extending parallel to each other from the current-collecting strip, and the negative electrodes being configured as grid plates and each including a current-collecting strip passing into a current-collecting lug and a bar grate arranged thereon, the bar grate providing grid arrays filled with active material, wherein the cores of the positive electrodes are oriented in such a manner as to run transversely to the height direction of the battery casing and that the current-collecting strip of the negative electrode is oriented in such a manner as to run in the height direction of the battery casing.

2. The battery according to claim 1, wherein the current-collecting strips are oriented in the height direction of the battery casing.

3. The battery according to claim 1, wherein the current-collecting strips are each configured in such a manner as to taper toward the end thereof opposite the connecting poles.

4. The battery according to claim 1, wherein the end section of the current-collecting strips on the side of the connecting poles each serve as a current-collecting lug.

5. The battery according to claim 1, wherein the cores have a star-shaped cross section.

6. The battery according to claim 1, wherein the current-collecting strip having the bar grate disposed thereon is manufactured as a drop cast part.

7. The battery according to claim 6, wherein the bar grate includes cross bars and main bars, wherein the cross bars run transversely to the height direction of the current-collecting strip and have a diameter exceeding that of the main bars.

8. The battery according to claim 7, wherein the cross bars of the negative electrodes and the cores of the positive electrodes are formed in such a manner as to be equally long in their respective extent in the longitudinal direction.
